(19) United States
(12) Patent Application Publication
(10) Pub. No.: US 2009/0187552 A1
(43) Pub. Date: Jul. 23, 2009

(54) System and Methods for Generating Data Analysis Queries from Modeling Constructs

(75) Inventors: Florian Pinel, New York, NY (US); Pawan Chowdhary, Montrose, NY (US); Frederick Y. Wu, Cos Cob, CT (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINE CORPORATION, Armonk, NY (US)

(21) Appl. No.: 12/015,869

(22) Filed: Jan. 17, 2008

(51) Int. Cl. G06F 7/10; G06F 17/30

(52) U.S. Cl. 707/5; 707/4; 707/E17.014

(57) ABSTRACT

A method for automatically generating data analysis queries from at least one modeling construct includes selecting a preconfigured template identifying at least one metric or dimension; retrieving dashboard model data comprising the preconfigured template; filtering to the dashboard model data using at least one user-specific access control; and automatically generating a query for at least one database.

### I. FIELD OF THE INVENTION

The present invention relates to a system and methods for automatically generating data analysis queries from modeling constructs (for example, an observation model, a data warehouse model, and a dashboard model) and user-specific access controls.

### II. BACKGROUND OF THE INVENTION

Model-driven business transformation is a model-driven technology developed by IBM® for enabling rapid, reliable and cost-effective transformation of business processes. The model-driven development framework uses a business observation model to formally define data to compute operational key performance indicators (KPIs).

A data warehouse model may be used to generate a data warehouse schema for KPIs, including quantifiable and measurable metrics. Metrics grouped in hierarchical fashion are called a dimension. Thus, an observation model comprises a list of values or data to compute KPIs; whereas, a data warehouse model determines interrelationships between those values, for example, in tables and columns in a database.

U.S. Patent Application Publication 2006/0112109 A1 discloses a hybrid approach for capturing metadata about Business Processing Monitoring (BPM) artifacts that is based on a combination of a relational metadata model and a semantic net. Metadata about metrics and situations and their dimensional context are first captured. Then, relational metadata are used to describe a generic data schema for metrics, situations and their dimensional context. The metadata from semantic nets are used to extend the metadata definitions. Data from a data warehouse are searched and managed with the schema described and managed with the relational and semantic net metadata.

A data warehouse schema may be used to display data and KPIs on a dashboard, a user interface that organizes and presents information in a way that is easy to read and interpret. The development and functionality of a dashboard may be model-driven and integrated with business performance models, as disclosed in Chowdhary et al., Model-Driven Dashboard for Business Performance Reporting, IBM Research Report (Jul. 10, 2006).

Current data queries require knowledge of the underlying database and data. Current data queries are also not customizable and provide no security at the database query level. Further, queries must be recreated when the database schema changes. Thus, there remains a need for automatically generating model-driven queries to a database, independent of knowledge of the database, and with appropriate user access controls.

### III. SUMMARY OF THE INVENTION

According to an aspect of the invention, a method is provided for automatically generating data analysis queries from modeling constructs. A preconfigured template is selected that identifies at least one metric or dimension. Dashboard model data is retrieved comprising the preconfigured template. The dashboard model data is filtered using at least one user-specific access control. A query for at least one database is automatically generated.

According to another aspect of the invention, a method for automatically generating data analysis queries from modeling constructs is provided. A preconfigured template identifying at least one metric or dimension is selected. Dashboard model data comprising the preconfigured template is retrieved. The scope of the at least one metric or dimension that the user is authorized to view is determined using at least one user-specific access control. A query for at least one database is automatically generated.

According to another aspect of the present invention, a system for generating data analysis queries is provided. The system includes an agent for generating data analysis queries from at least one modeling construct, at least one client, and at least one database comprising the at least one modeling construct.

According to another aspect of the invention, a computer program product is provided comprising a computer useable medium having a computer readable program. When executed on a computer, the computer readable program causes the computer to select a preconfigured template identifying at least one metric or dimension; retrieve dashboard model data comprising the preconfigured template; filter the dashboard model data using at least one user-specific access control; and automatically generate a query for at least one database.

As used herein “substantially”, “relatively”, “generally”, “about”, and “approximately” are relative modifiers intended to indicate permissible variation from the characteristic so modified. They are not intended to be limited to the absolute value or characteristic which it modifies but rather approaching or approximating such a physical or functional characteristic.

In the detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

Given the following enabling description of the drawings, the system and methods should become evident to a person of ordinary skill in the art.

### IV. BRIEF DESCRIPTION OF THE DRAWINGS

FIG. 1 is a class diagram illustrating dashboard model data and user-specific data for query generation according to an embodiment of the present invention.

FIG. 2 illustrates a flowchart for retrieving dashboard model data and retrieving user-specific data according to FIG. 1.

FIG. 3 illustrates a flowchart for generating an SQL query according to an embodiment of the invention.

FIG. 4 illustrates a flowchart for generating an MDX query according to an embodiment of the invention.

FIG. 5 illustrates an example of a method for generating a query according to an embodiment of the present invention.

FIG. 6 illustrates a system according to an embodiment of the invention.

FIG. 7 illustrates an exemplary agent according to an embodiment of the invention.

### V. DETAILED DESCRIPTION OF THE DRAWINGS

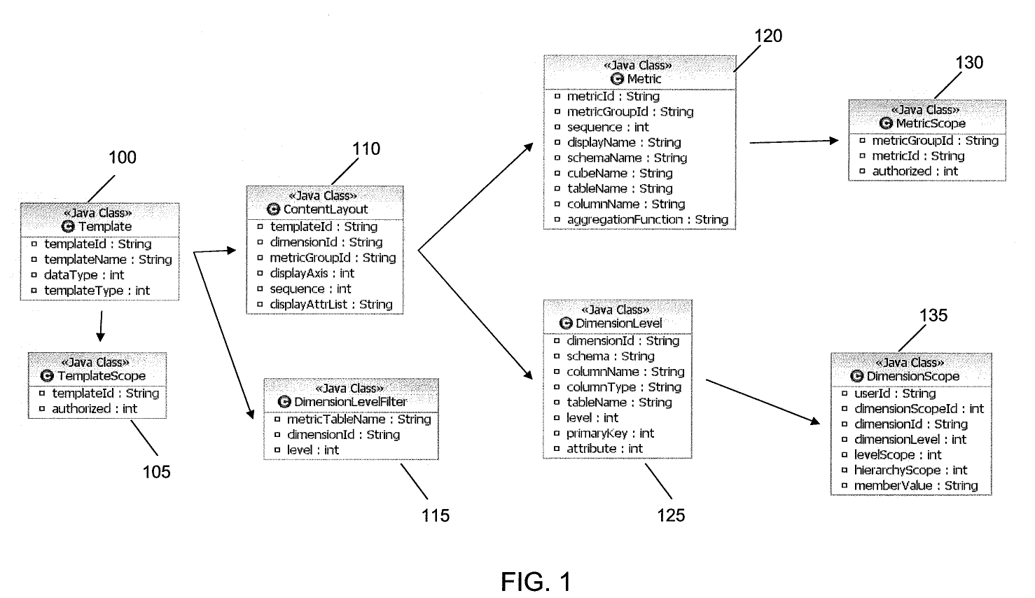

FIGS. 1-7 illustrate a system and methods for automatically generating queries from modeling constructs (such as an observation model, a data warehouse model, and a dashboard model) and user-specific access controls. The system and methods of the present invention are advantageous because they are independent of the underlying database. In addition, user-specific access controls may be applied to the generated queries at runtime. According to the present invention, one query may be transformed into different queries depending upon the user requesting the data. Also, multiple query languages may be created.

According to the present invention, at least one database comprises at least one of an observation model, a data warehouse model, a dashboard model, or combinations thereof. Use of the term “model” or “modeling constructs” throughout the application is intended to cover both models and metamodels. The user-specific access controls may be stored in the same database or a different database than the modeling constructs.

The observation model defines data to compute operational key performance indicators (KPIs). The data warehouse model generates a data warehouse schema (e.g., star schema) for KPIs, including quantifiable and measurable metrics. In embodiments, the data warehouse may comprise an adaptive data warehouse model, which is a combination of a relational metadata model and a semantic net. A dashboard model displays KPIs on a graphical user interface based upon the data warehouse schema.

FIG. 1 illustrates a class diagram for the beginning of generating a query according to the present invention using dashboard model data and user-specific data. Although a JAVA® class is illustrated, the present invention is not limited to a particular programming language.

In FIG. 1, query generation begins when a user selects a preset or preconfigured template, which represents a query, 100. The template may be preconfigured to include at least one of a template ID, template name; data type (e.g., the language of the query, for example, SQL or MDX); and template type (e.g., how the query results will be displayed, such as in a graph, table, chart, etc.). In embodiments, a list of templates may be made available to a user in the form of a list or drill down menu in a graphical user interface (GUI).

Once the user selects a template, the user's authority to access the template is determined by the template scope 105 (Template Scope). In certain embodiments, authority to access a template may be based upon at least one user-specific access control. The at least one user-specific access control may include, but is not limited to, user ID, screename, password, user role (e.g., manager, executive, administrator), or any combination thereof. If the user is not authorized to access the template, query generation is aborted.

The content layout of the selected template is determined 110 (Content Layout). At least one metric or dimension that is part of the template is identified, as well as the proper sequence and display of the results of the query, for example, in a dashboard.

For each metric present in the selected template, the location of the metric in the database is determined 120 (Metric). In embodiments, each metric may be identified by at least one of metric ID, metric group ID, sequence, display name, schema name, cube name, table name, column name, or aggregate function. In embodiments, aggregate function specifies the way data may be aggregated to compute a metric value. Possible aggregate functions include, but are not limited to, sum, count, count distinct, average, and the like. For example, if the data warehouse contains an order table in which each entry is a sales order composed of an order number and revenue, there may be 2 metrics: (1) number of orders=the count of distinct order numbers, and (2) total revenue=the sum of all order revenues.

Using at least one user-specific access control, metrics are automatically filtered by restricting the scope to only those metrics that the user is allowed or authorized to view 130 (Metric Scope).

For each dimension that is part of the query, the location of the dimension level in the database is determined 125 (Dimension Level). In embodiments, each dimension level is identified by at least one of dimension ID, schema name, column name, column type, table name, level, primary key (e.g., the primary level if a dimension has more than one level), and attribute (e.g., if two dimension levels are equivalent, one is primary and the other is an attribute).

Using at least one user-specific access control, dimension levels are automatically filtered by restricting the scope of the dimension levels (i.e., constraints or values of a given level) only to that which the user is allowed or authorized to view 135 (Dimension Scope). For example, if relevant geographic dimension level is Europe, the dimension scope may limit the query and the resulting displayed data to France or Germany.

The dimension scope may be identified by at least one parameter such as user ID, dimension scope ID, dimension level, level scope, hierarchy scope, or member value. In embodiments, a user may add at least one parameter to a query to further restrict the dimension scope. For example, a user may indicate that there is only an interest in data for Germany.

A Dimension Level Filter 115 is a dimension scope that is not explicitly connected to the content layout, but must be applied anyway. For example, a query for a bank account may be “show the sum of the debits broken down by month”. In this example, there are 2 content layouts: one pointing to the “debit” metric, and one pointing to the “time” dimension. There is also a dimension level filter, the bank account ID. It is implicit that a user should only see the debits for his or her account.

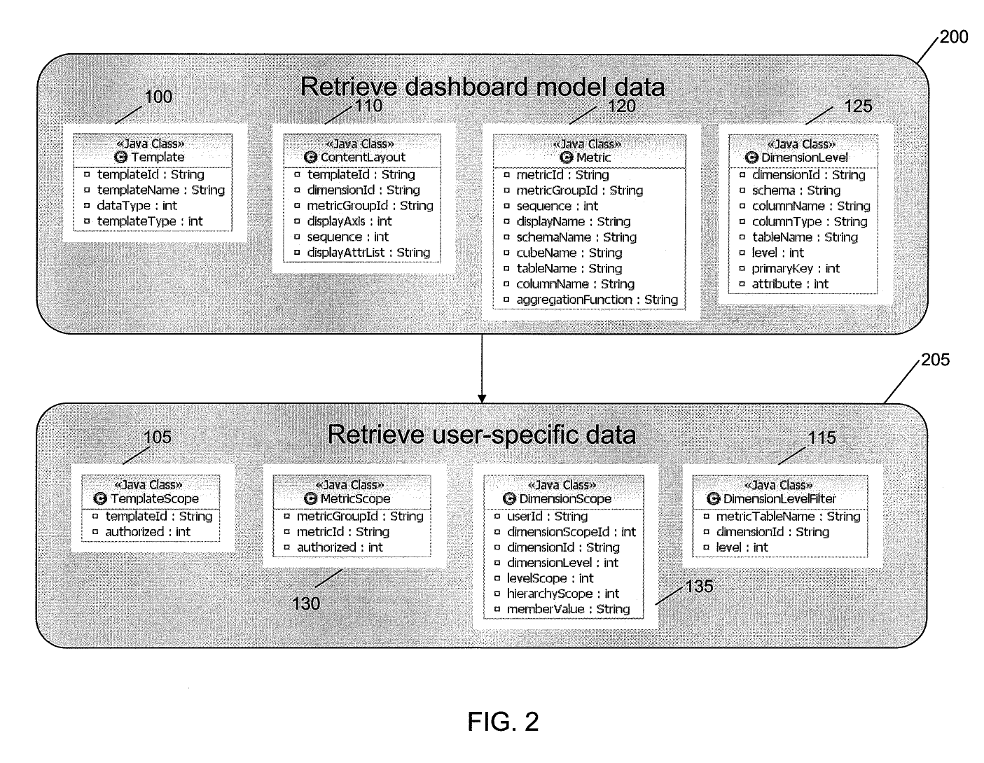

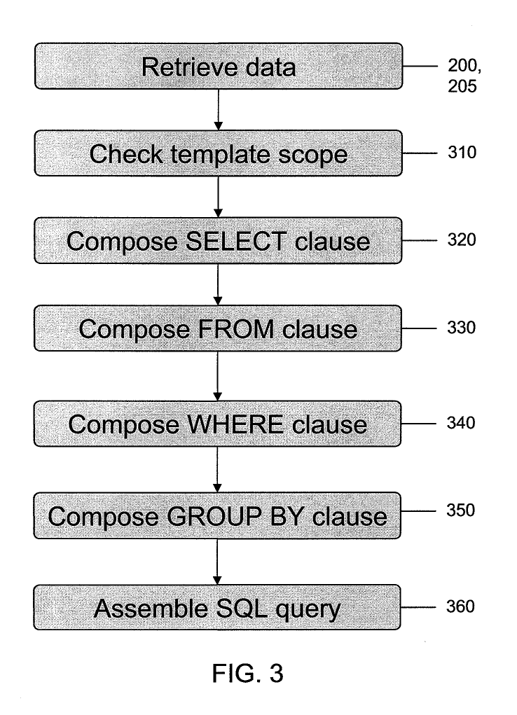

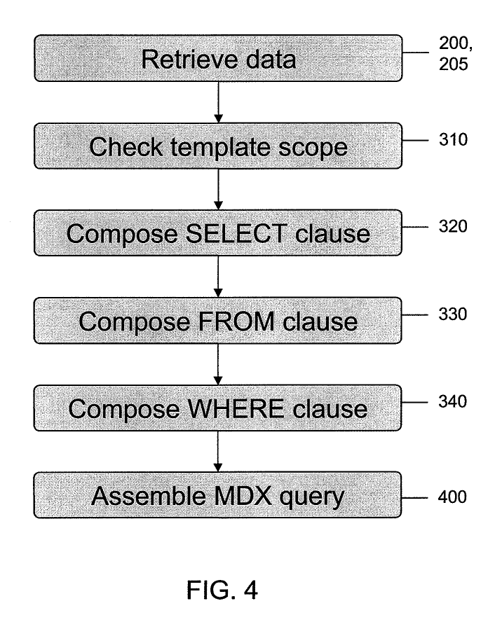

The class diagram of FIG. 1 is further illustrated by the flowchart of FIG. 2. Once a template is selected, the corresponding dashboard model data is automatically retrieved, 200, from the at least one database containing the modeling constructs. The user-specific data (i.e., at least one user-specific access control) is also automatically retrieved and applied to filter the dashboard model data 205. After retrieving the dashboard model data and applying the at least one user-specific access control, a query to the at least one database is automatically generated, for example, via a query generator, as illustrated in FIGS. 3-4.

In embodiments, the query is automatically generated in a format specified in the preconfigured template, for example, in Structured Query Language (SQL) format, Multidimensional Expressions (MDX) format, or an XML query language format, such as XQuery. Alternatively, a user may select the form of the query used. Thus, according to the present invention, a query may be generated independent of the underlying system. In embodiments, a user may also have the option to directly return query results as an array.

A method for generating a Structured Query Language (SQL) data analysis query is shown in FIG. 3. Based upon a selected template, the dashboard model data is retrieved 200 and user-specific data 205 is retrieved, as illustrated in FIG. 2. The template scope is determined 310. A SELECT clause 320, a FROM clause 330, a WHERE clause 340, and a GROUP BY clause 350 are automatically generated. The final SQL query is then assembled by combining the clauses 360; applied to the at least one database; and displayed in a dashboard for the user. Each of these steps is described below.

In embodiments, a SELECT clause is automatically generated by gathering metric and dimension column names from the content layout (e.g., representing a column or row). Unauthorized metrics and dimensions are removed using metric scope and dimension scope.

In embodiments, a FROM clause is automatically generated by gathering metric table names from the content layout. Dimension table names are gathered and column names are joined from the content layout and filtered via the dimension level filter. All identified table names and column names are joined.

In embodiments, the WHERE clause is automatically generated by gathering parameters, member values for the dimension levels or metrics present in the content layouts, and dimension level filters. A WHERE clause is created from the identified parameters and member values.

The GROUP BY clause is used to combine, or group, data. In embodiments, the GROUP BY clause is automatically generated by gathering dimension table and column names from content layouts. A GROUP BY clause is created from all dimension table and column names.

An SQL query to the at least one database and at least one modeling construct therein is automatically generated by assembling the SELECT clause, the FROM clause, the WHERE clause, and the GROUP BY clause. The data retrieved from the at least one database as a result of the SQL query is displayed in a dashboard for the user.

Similarly, as illustrated in FIG. 4, a Multidimensional Expressions (MDX) query may be generated and assembled 400. The MDX query does not have a GROUP BY clause as the relationship between metrics (measures) and dimensions are already established in an OLAP cube.

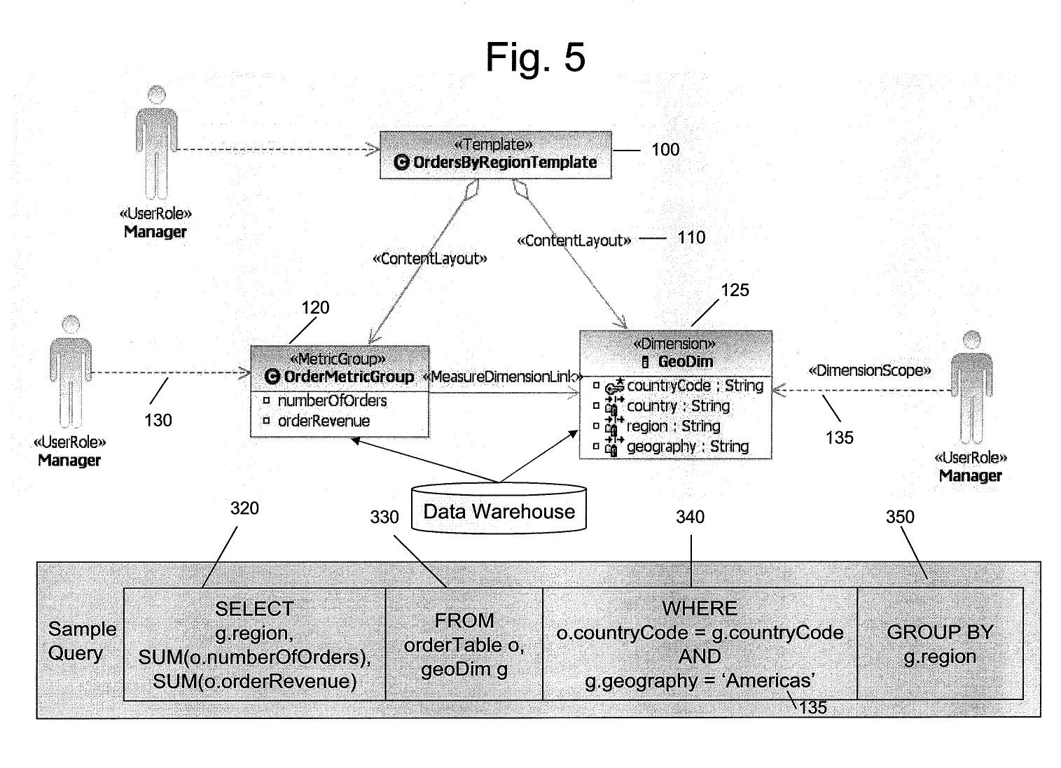

FIG. 5 illustrates an example of generating data queries according to the present invention. A user (user role Manager) selects a template representing a query to display orders (metrics) by geographic region (dimension) 100. The user role is analyzed by the template scope to see if the Manager is authorized to run the template/query 105. The content layout is determined 110. The metrics from the content layout are identified and are located in the at least one database 120. The metrics include number or orders and order revenue. The dimension from the content layout is identified and is located in the at least one database 125. The dimension includes hierarchical data related to various geographic regions. The user role Manager is used to filter the scope of the metrics 130. The specific user ID of the Manager is used to filter the geographic region to the Americas 135. The user role Manager is also used to filter the constraints of the dimension level 135. A SQL query is automatically generated by composing and combining Select, From, Where, and Group By clauses.

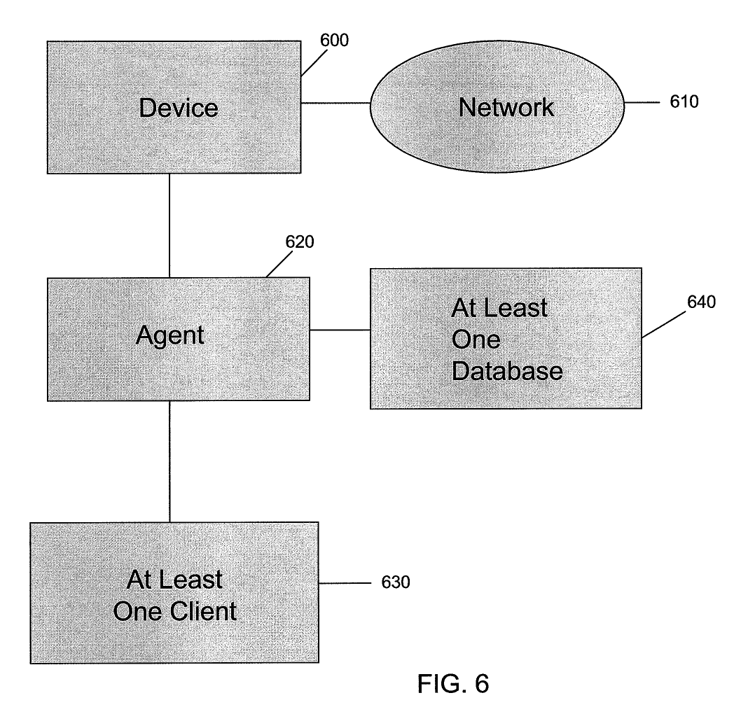

FIG. 6 is a block diagram showing an illustrative system of the invention. The illustrative system includes at least one electronic or digital device 600 (e.g., a personal computer, cellular telephone, personal digital assistant or PDA, game device, MP3 player, television). The at least one device may be connected to a network 610 (e.g., the internet, World Wide Web, intranet, local area network (LAN), wide area network (WAN)).

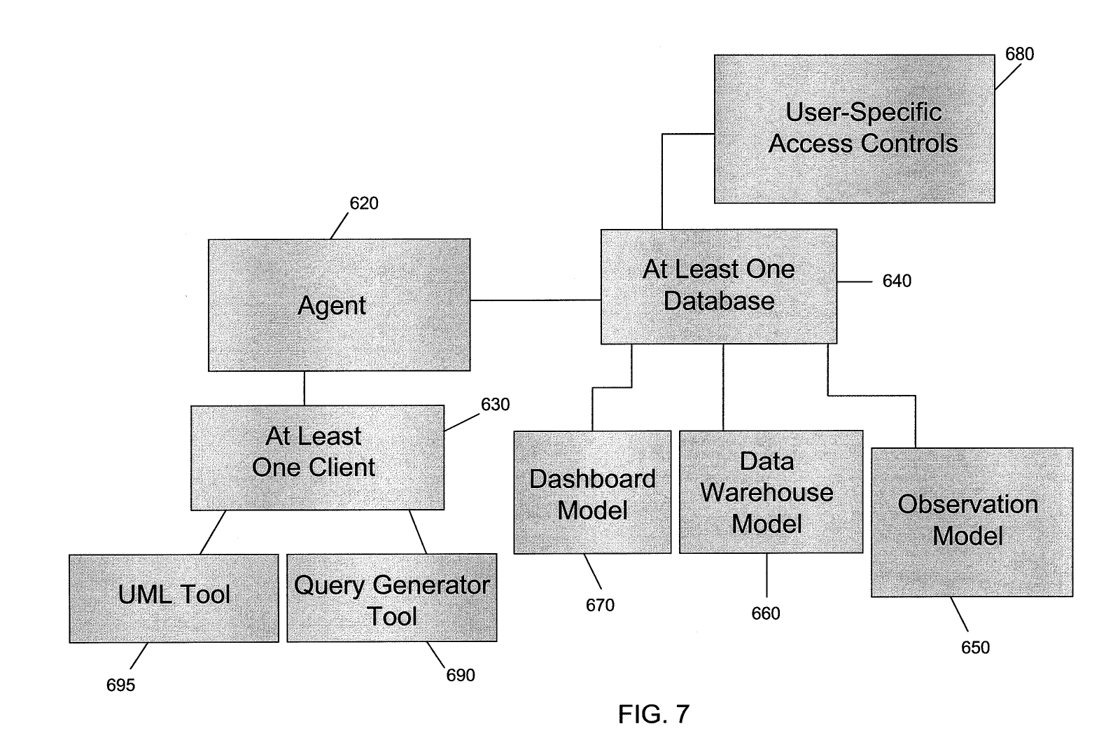

In embodiments, the system includes an agent 620 for automatically generating a query based upon modeling constructs; at least one client 630; and at least one database 640 for storing at least one of an observation model 650, a data warehouse model, or a dashboard model 670, and user-specific access controls 680 (FIG. 7). The agent and at least one client may be applications residing on the at least one electronic or digital device. The illustrative system is but one example, and one of ordinary skill in the art would recognize that many other variations may exist, all of which are contemplated by the invention.

FIG. 7 illustrates an exemplary agent 620 of the invention. The agent 620 includes at least one client 630 comprising at least one of a query generator tool 690. In embodiments, the query generator tool may comprise a JAVA® class (e.g., SQL or MDX) that can be a standalone application or initiated by any web application. The query generator tool may comprise a JavaServer Pages (JSP) tag library wrapper, thereby allowing a user to specify what query format is desired and the JSP tag library wrapper will select the appropriate generator tool. A UML tool 695, for example IBM Rational® Software Architect, may be used for capturing UML representation of the modeling constructs. IBM® Websphere Portlet Factory or IBM® DB2 Alphablox may be used to display KPIs in a dashboard.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of at least one general purpose computer, special purpose computer(s), or other programmable data processing apparatus to produce a machine, such that the instructions, which execute via the processor of the computer or other programmable data processing apparatus, create means for implementing the functions specified in the flowcharts or block diagrams.

The exemplary and alternative embodiments described above may be combined in a variety of ways with each other. Furthermore, the steps and number of the various steps illustrated in the figures may be adjusted from that shown.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

1. A method for automatically generating data analysis queries from at least one modeling construct, comprising:
selecting a preconfigured template identifying at least one metric or dimension;
retrieving dashboard model data comprising the preconfigured template;
filtering to the dashboard model data using at least one user-specific access control; and
automatically generating a query for at least one database.

2. A method according to claim 1, further comprising presenting query results in a dashboard.

3. A method according to claim 1, wherein the at least one database comprises at least one of an observation model, a data warehouse model, or a dashboard model.

4. A method according to claim 1, wherein the at least one database comprises a data warehouse model and a dashboard model.

5. A method according to claim 1, wherein the at least one database comprises the at least one user-specific access control.

6. A method according to claim 5, wherein the at least one user-specific access control comprises at least one of user ID, screename, password, or user role.

7. A method according to claim 1, wherein the dashboard model data further comprises the layout of the at least one metric or dimension in the dashboard.

8. A method according to claim 1, wherein said filtering comprises checking the template to determine if a user is allowed to select the template and run a query.

9. A method according to claim 1, wherein said filtering comprises determining the scope of the at least one metric or dimension that a user is authorized to view.

10. A method according to claim 1, wherein said filtering comprises determining the level of a dimension which the user is authorized to access.

11. A method according to claim 1, wherein retrieving the dashboard model data from the at least one database comprises:
determining the content layout of the at least one metric or dimension; and
locating at least one metric or dimension in the at least one database.

12. A method according to claim 1, wherein the query is generated in SQL format.

13. A method according to claim 1, wherein the query is generated in MDX format.

14. A method for automatically generating data analysis queries from modeling constructs, comprising:
selecting a preconfigured template identifying at least one metric or dimension;
retrieving dashboard model data comprising the preconfigured template;
determining the scope of the at least one metric or dimension that a user is authorized to view using at least one user-specific access control; and
automatically generating a query for at least one database.

15. A method according to claim 14, further comprising determining whether the user is authorized to access the template.

16. A system for generating data analysis queries, comprising:
an agent for generating data analysis queries from at least one modeling construct;
at least one client;
at least one database comprising the at least one modeling construct.

17. A system according to claim 16, wherein the at least one client comprises at least one of a query generator tool or a UML tool.

18. A system according to claim 16, wherein the at least one modeling construct comprises at least one of a dashboard model, an observation model, or a data warehouse model.

19. A system according to claim 16, where the at least one database further comprises at least one user-specific access control.

20. A computer program product, comprising:
a computer useable medium having a computer readable program, wherein the computer readable program when executed on a computer causes the computer to:
select a preconfigured template identifying at least one metric or dimension;
retrieve dashboard model data comprising the preconfigured template;
filter the dashboard model data using at least one user-specific access control; and
automatically generate a query for at least one database.
